(19) United States
(12) Patent Application Publication
(10) Pub. No.: US 2015/0364059 A1
(43) Pub. Date: Dec. 17, 2015

(54) INTERACTIVE EXERCISE MAT

(71) Applicants: Steven A. Marks, Palm Beach Gardens, FL (US); Maziar Sadri, Santa Clara, CA (US); Neyma G. Jahansooz, Carlsbad, CA (US)

(72) Inventors: Steven A. Marks, Palm Beach Gardens, FL (US); Maziar Sadri, Santa Clara, CA (US); Neyma G. Jahansooz, Carlsbad, CA (US)

(21) Appl. No.: 14/741,190

(22) Filed: Jun. 16, 2015

Related U.S. Application Data
(60) Provisional application No. 62/012,625, filed on Jun. 16, 2014.

(51) Int. Cl. G09B 19/00; A63B 21/00

(52) U.S. Cl. CPC G09B 19/0038; A63B 21/1473; A63B 2208/02

(57) ABSTRACT

A smart mat system is provided for performing exercises herein. The smart mat system may include an exercise mat. The exercise mat may include sensors configured for sensing objects. The sensors may transmit sensor information to a mobile component. The mobile component may determine a user's balance, weight distribution, and correctness of a pose. The mobile component may store historic data associated with the user's exercises.

### CROSS-REFERENCE TO RELATED APPLICATION

This application claims priority to U.S. Provisional Application No. 62/012,625 entitled “INTERACTIVE EXERCISE MAT,” filed on Jun. 16, 2014, which is hereby incorporated by reference in its entirety.

### FIELD

The present technology relates to physical exercise and related exercise apparatuses.

### BACKGROUND

Over the years, various systems and methodologies for promoting wellness, physical activity, education, or brain development have been created. See, e.g., U.S. Pat. No. 7,108,635 to Howlett-Campanella, entitled “Yoga Mat with Body Contact Placement Indicia”, U.S. Pat. No. 5,949,951 to Omnimedia Systems, Inc., entitled “Interactive Workstation for Creating Customized, Watch and Do Physical Exercise Programs”, and, U.S. Pat. No. 7,063,535 to Stamm et al., entitled “System and Method for Facilitating Early Childhood Brain Development.” Moreover, various setups have been developed for interactive systems suitable for facilitating physical activity. See, e.g., U.S. Pat. No. 8,235,870 to Phresh, LLC, entitled “Method and Apparatus for Integrating Physical Exercise and Interactive Multimedia.” However, a number of drawbacks exist with respect to these prior systems and methods, including not integrating real time feedback on users' exercise technique.

Modern, sedentary lifestyles often are characterized by activities such as watching television and movies, using the computer and internet, and playing games on the internet or on gaming systems, and lend themselves to many potential health concerns. As a result of modern lifestyles, the Surgeon General warns that this generation of children may be the first with a life expectancy lower than that of its parents. Moreover, as many as 1 in 3 children are predicted to develop diabetes by age 20. Therefore, it is desirable to provide systems and methodologies for improving wellness through physical exercise and education while also appealing to modern lifestyles.

The present technology seeks to provide a system and apparatus for integrating physical exercise and interactive multimedia, with the system and apparatus being fun and educational, promoting health and wellness, and appealing to those with modern lifestyles. Moreover, the present technology seeks to provide a means for making health and exercise readily available and accessible through the use of education and entertainment platforms. The present technology seeks to provide an apparatus and system that may be used interactively with multimedia and can provide real time feedback to the user to provide for a fun, healthy experience. It is noted that other benefits of the subject disclosure may be apparent.

### SUMMARY OF THE INVENTION

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

Interactive exercise mat apparatuses, systems, and methods of use are shown and described In one embodiment, an exercise mat may include electrical hardware, sensors, and a wired or wireless software application configured to optimize exercise mechanics and training routines, e.g., a yoga practice. The mat may be a pressure sensing yoga mat that may communicate via Bluetooth or other wired or wireless compatible communication protocol to a smart phone, tablet, computer, or other device. The mat may assist a user in performing yoga and other exercises with real time data of weight distribution and position of the user's body as it applies pressure to the yoga mat. This data may be processed and compared to an ideal position for each yoga pose, and feedback may be provided to the user to correct or confirm proper weight distribution and position. A processor may be operatively connected to the yoga mat that reads and processes data relating to weight distribution and position of the user. This data may be sent to a second processor that has additional data regarding the user. The second processor may then compare ideal weight and position data and provide feedback to the user.

The mat may replace the need to have a private teacher by offering dynamic real time instruction personalized to a user's body type and practice via advanced in-mat sensors that connect with an application (or “app”) on a computing device, such as a smart phone or tablet computer. The mobile component 307 may provide the user with real time feedback and adjustments, giving the users the ability to practice and achieve a more ideal pose. The users may use the mat and mobile component 307 to measure and record improvements and interactively follow top yoga instructors at home on their personal schedule.

The following description and the drawings disclose various illustrative aspects. Some improvements and novel aspects may be expressly identified, while others may be apparent from the description and drawings.

### BRIEF DESCRIPTION OF THE DRAWINGS AND ATTACHMENTS

The accompanying drawings illustrate various systems, apparatuses, devices and methods, in which like reference characters refer to like parts throughout, and in which:

FIG. 1 is a cross-sectional view of an embodiment of an exercise mat;

FIG. 2A is a view of an embodiment of a sensor layer;

FIG. 2B is a detailed view of an embodiment of a sensor layer;

FIG. 3 is a functional block diagram of a smart mat system;

FIG. 4 is a functional flow diagram of a smart mat system process as described herein;

FIG. 5 is a functional block diagram of a smart mat system in a registration process;

FIG. 6 is a functional block diagram of a smart mat system in a calibration process;

FIG. 7 is a functional block diagram of a smart mat system in an in-home mode;

FIG. 8 is a rendering of a smart mat system in an in-home mode with a balance board;

FIG. 9 is another rendering of a smart mat system in an in-home mode with a balance board;

FIG. 10 is another rendering of a smart mat system in an in-home mode with a balance board;

FIG. 11 is a rendering of a smart mat system in an in-class mode;

FIG. 12 is another rendering of a smart mat system in an in-class mode with a balance board;

FIG. 13 is another rendering of a smart mat system in an in-class mode with a balance board;

FIG. 14 is a rendering of a smart mat system in a non-activity mode;

FIG. 15 is a rendering of a smart mat system in a Zen-mode mode;

FIG. 16 is a flow diagram of an exemplary method associated with a smart mat system in accordance with various embodiments described here;

FIG. 17 is an environmental diagram of an exemplary communication system in accordance with various embodiments disclosed herein; and

FIG. 18 is a block diagram of a functional computer system in accordance with various embodiments described here.

### DETAILED DESCRIPTION

Reference will now be made in detail to exemplary embodiments of the present technology, examples of which are illustrated in the accompanying figures. It is to be understood that other embodiments may be utilized and structural and functional changes may be made without departing from the respective scope of the technology. Moreover, features of the various embodiments may be combined or altered without departing from the scope of the technology. As such, the following description is presented by way of illustration only and should not limit in any way the various alternatives and modifications that may be made to the illustrated embodiments and still be within the spirit and scope of the technology.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Moreover, terms such as “access point,” “server,” and the likes, are utilized interchangeably, and refer to a network component or appliance that serves and receives control data, voice, video, sound, or other data-stream or signaling-stream. Data and signaling streams may be packetized or frame-based flows. Furthermore, the terms “user,” “customer,” “consumer,” and the like are employed interchangeably throughout the subject specification, unless context suggests otherwise or warrants a particular distinction among the terms. It is noted that such terms may refer to human entities or automated components supported through artificial intelligence (e.g., a capacity to make inference).

“Logic” refers to any information and/or data that may be applied to direct the operation of a processor. Logic may be formed from instruction signals stored in a memory (e.g., a non-transitory memory). Software is one example of logic. In another aspect, logic may include hardware, alone or in combination with software. For instance, logic may include digital and/or analog hardware circuits, such as hardware circuits comprising logical gates (e.g., AND, OR, XOR, NAND, NOR, and other logical operations). Furthermore, logic may be programmed and/or include aspects of various devices and is not limited to a single device.

A network typically includes a plurality of elements that host logic. In packet-based wide-area networks (WAN), servers (e.g., devices comprising logic) may be placed at different points on the network. Servers may communicate with other devices and/or databases. In another aspect, a server may provide access to a user account. The “user account” includes attributes for a particular user and commonly include a unique identifier (ID) associated with the user. The ID may be associated with a particular mobile device(s) owned by the user. The user account may also include information such as relationships with other users, application usage, location, personal settings, and other information.

Embodiments may utilize substantially any wired or wireless network. For instance, embodiments may utilize various radio access network (RAN), e.g., Wi-Fi, global system for mobile communications, universal mobile telecommunications systems, worldwide interoperability for microwave access, enhanced general packet radio service, third generation partnership project long-term evolution (3G LTE), fourth generation long-term evolution (4G LTE), third generation partnership project 2, BLUETOOTH®, ultra mobile broadband, high speed packet access, xth generation long-term evolution, or another IEEE 802.XX technology. Furthermore, embodiments may utilize wired communications.

It is noted that, terms “user equipment,” “device,” “user equipment device,” “client,” and the like are utilized interchangeably in the subject application, unless context warrants particular distinction(s) among the terms. Such terms may refer to a network component(s) or appliance(s) that sends or receives data, voice, video, sound, or substantially any data-stream or signaling-stream to or from network components and/or other devices. By way of example, a user equipment device may comprise an electronic device capable of wirelessly sending and receiving data. A user equipment device may have a processor, a memory, a transceiver, an input, and an output. Examples of such devices include cellular telephones (e.g., smart phones), personal digital assistants (PDAs), portable computers, tablet computers (tablets), hand-held gaming counsels, wearables (e.g., smart watches), desktop computers, etc.

It is noted that user equipment devices can communicate with each other and with other elements via a network, for instance, a wireless network, or a wireline network. A “network” can include broadband wide-area networks such as cellular networks, local-area networks, wireless local-area networks (e.g., Wi-Fi), and personal area networks, such as near-field communication networks including BLUETOOTH®. Communication across a network may include packet-based communications, radio and frequency/amplitude modulations networks, and the likes. Communication may be enabled by hardware elements called “transceivers.” Transceivers may be configured for specific networks and a user equipment device may have any number of transceivers configured for various networks. For instance, a smart phone may include a cellular transceiver, a Wi-Fi transceiver, a BLUETOOTH® transceiver, or may be hardwired. In those embodiments in which it is hardwired, any appropriate kind or type of networking cables may be utilized. For example, USB cables, dedicated wires, coaxial cables, optical fiber cables, twisted pair cables, Ethernet, HDMI and the like.

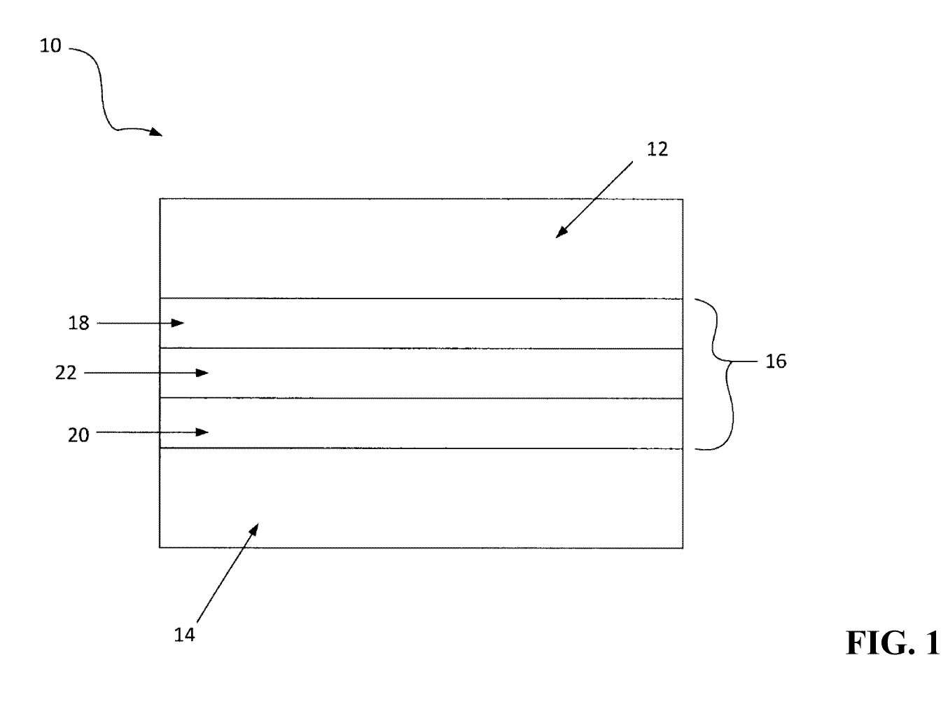

As shown in the drawings for purposes of illustration, the present technology is concerned with an exercise mat 10, as shown in FIG. 1. Mat 10 may be of a variety of shapes and sizes, including, but not limited to, rectangular, elliptical, and circular. For example, mat 10 may be rectangular in shape with dimensions of approximately 24 inches in width and 68 inches in length. Mat 10 may be formed from one or more of a variety of materials including, but not limited to, polyvinyl chloride, thermoplastic elastomer, rubber, ethylene vinyl acetate, polymer resin, cotton, microfiber, polyester, wool, or a moisture absorbent fabric. The material of mat 10 may be flexible enough so that mat 10 may be folded or rolled. Mat 10 may also include an anti-skid coating or a similar coating. Mat 10 may be heat resistant, for example, up to at least 110° F. Additionally, mat 10 may be waterproof or water resistant. Mat 10 may be any color and it may have textures, printed designs, or symbols on its surfaces.

Mat 10 may have several layers including a top cover 12 overlying a bottom cover 14. Mat 10 may include a sensor array 16 located between top cover 12 and the bottom cover 14 of mat 10. Sensory array 16 may be formed of one or more layers, such as a top electrode layer 18 overlying a bottom electrode layer 20, with a sensor layer 22 in between top electrode layer 18 and bottom electrode layer 20. In at least one embodiment, mat 10 may not comprise any sensor layers, but may be placed over a mat comprising a sensor layer. For example, a user may place a first mat or towel over mat 10 which may comprise the sensors.

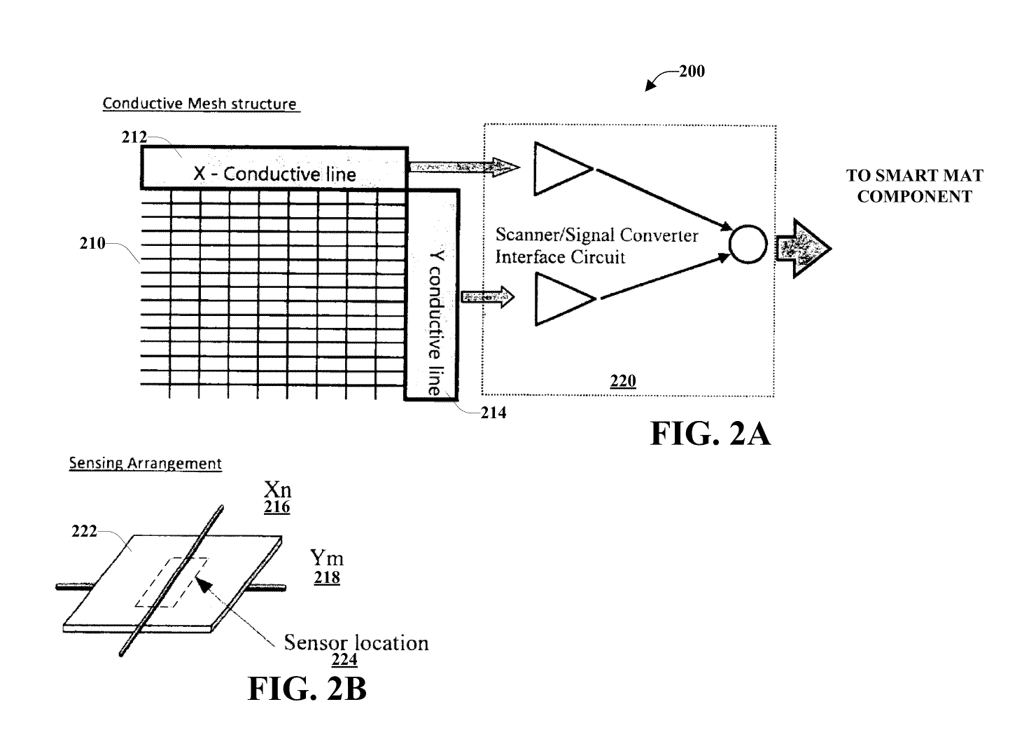

The sensor layer may include a variety of sensor types, including, but not limited to, pressure sensors, piezoresistive sensors, weight sensors, movement sensors, and temperature sensors. The sensor layer of a single mat also may include many different types of sensors or only one type of sensor. The sensor layer may gather information from a user in a variety of appropriate methods. For example, in one embodiment shown in FIG. 2A, a conductive mesh structure 210 may gather sensory information from a user and determine pressure data that can be communicated to a control component. The control component may be comprised by the mat 10 or may be comprised in a separate device (e.g., smart phone, lap top computer, set top box, etc.).

The mesh structure may comprise a X-conductive line 212 and a Y-conductive line 214. A set comprising an X-conductive line 212, which may comprise top electrode layer 18, and a Y-conductive line 214, which may comprise bottom electrode layer 20, readings may define a location on or of mat 10. As depicted in FIG. 2B, the X-conductive line 212 and Y-conductive line 214 may comprise an array of n X-conductive lines and m Y-conductive lines, where n and m are numbers. For example, conductive line Xₙ 216 and a Y conductive line Yₘ 218 may intersect at a position associated with mat 10. In an aspect, Xₙ 216 may be placed about perpendicularly with Yₘ 218. In another aspect. a sensor layer 222 may be disposed between Xₙ 216 and Yₘ 218. An area proximal to the intersection of Xₙ 216 and Yₘ 218 may comprise a sensor location 224.

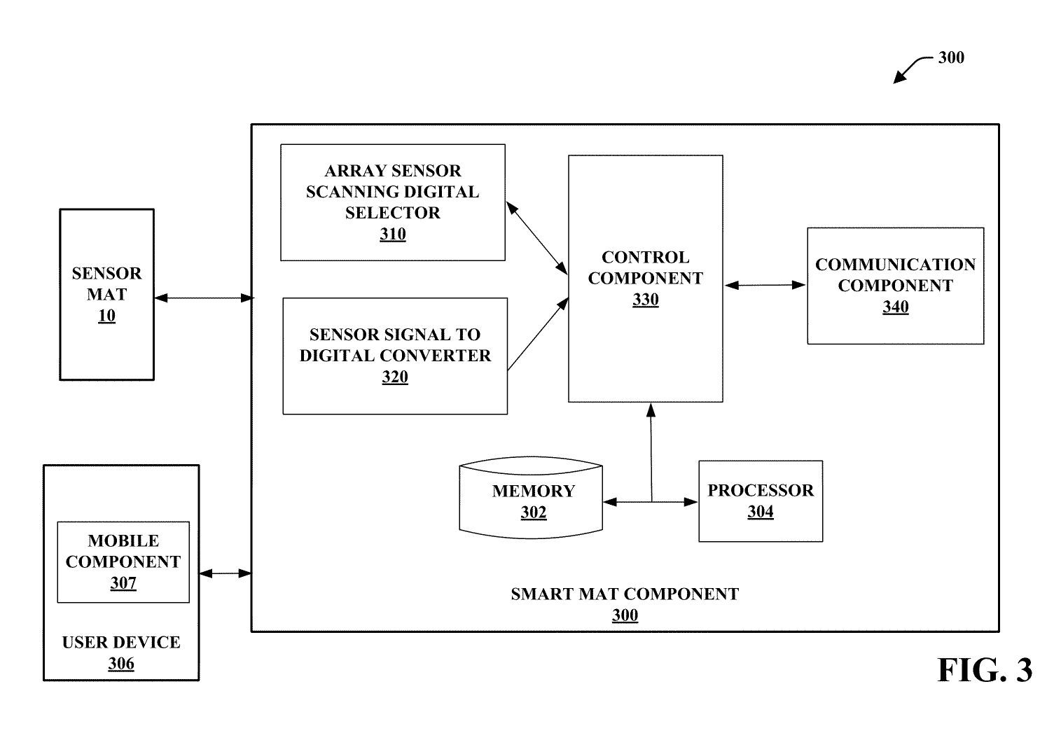

In an embodiment, X-conductive line 212 and a Y-conductive line 214 may generate output in response to sensing of pressure, weight, motion, or the like. The output may be converted by a Scanner/Signal converter interface circuit 220. The interface circuit 220 may comprise one or more converters (e.g., analog-to-digital converters (ADC)) that may convert the output into data which may be processed by a smart mat component, such as smart mat component 300 of FIG. 3.

FIG. 3 depicts a smart mat system 300 that may primarily comprise smart mat component 301 and smart mat 10. Smart mat component 301 may primarily include array sensor scanning digital selector 310, sensor signal to digital converter 320, control component 330, memory 302, processor 304, and communication component 340.

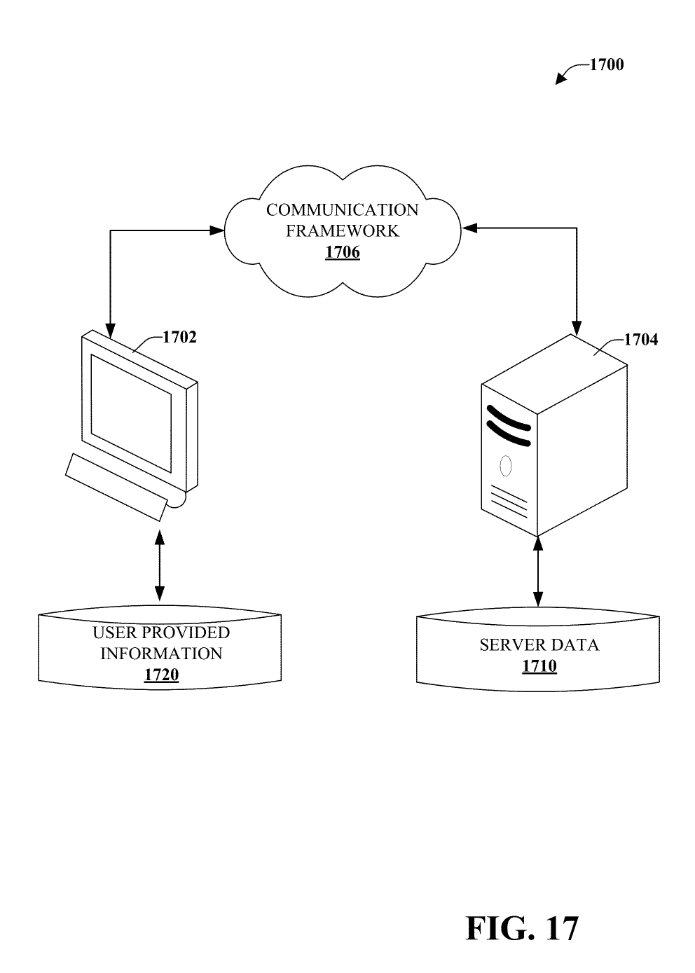

Memory 302 may be configured for storing computer executable components (e.g., control component 330) or instructions. Processor 304 may facilitate operation of the computer executable instructions. It is noted that system 300 may include one or more devices, such as a user device, sensor mat 10, display devices, or the like. It is further noted that one or more devices may comprise, at least in part, the various components. While shown as separate or distinct components, the components of system 300 may be comprised by one or more components. For instance, smart mat 10 may comprise smart mat component 300 and/or may be coupled with smart mat component 300, such as via a wireless or wired connection. Further, the system 300 may include a plurality of mats 10 and/or smart mat components 300 that may be linked together through a network and transceivers. These smart mats may be operatively linked with a server that may communicate with the smart mat systems, such as described in FIG. 17.

In an aspect, sensor data from mat 10 may be received by sensor signal to digital converter 320. The sensor signal to digital converter 320 may output digital data to a control component 330. The control component 330 may communicate with array sensor scanning digital selector 310 to determine sensor information. For instance, control component 330 may determine a location associated with mat 10 and sensed information, values associated with sensed information (e.g., pressure, weight, etc.), or the like.

Communication component 340 may be configured to facilitate communication with various components or devices. In an aspect, communication component 340 may comprise components for wireless or wired communication (e.g., adaptors, ports, transceivers, receivers, etc.). It is noted that the communication component 340 may be configured for one or more different types of communication protocols as described herein. For example, communication component 340 may be configured for BLUETOOTH™ communication with a user device 306. The user device 306 may include various devices. Such devices may include wearable electronics (e.g., smart watches, etc.), laptop computers, desktop computers, tablet computers, gaming devices (e.g., handheld gaming devices, set top boxes, etc.), and the like. In an aspect, smart mat component 300 may include a first user device (e.g., smart phone) that may be connected to sensor mat 10 and may communicate with a second user device 306 (e.g., smart television, tablet computer, etc.).

In at least one embodiment, the sensors and associated hardware may be charged via electrical power through any appropriate means. For instance, the electrical power connection may comprise a connection to power mains (e.g., wall outlet, USB outlet, etc.), wireless charging pads, or a battery that may be charged through a detachable charging dock, including a plug for an electrical outlet, a battery, or a USB connection. Additionally, the sensors and hardware may be able to hold their charge without being directly connected to a power source, allowing the user portability and flexibility in the location of the mat 10. For example, the hardware may be configured to maintain its charge for measuring and transmitting measurements for periods up to 120 minutes or more.

The mat 10 may be divided into different zones, for example, two zones, three zones, four zones, five zones, six zones, seven zones, or more zones. For example, in one embodiment, the sensor layer of the mat may be divided into six zones, two in a horizontal direction and three in a lengthwise direction. The middle two zones of the mat may not have sensors, but the remaining four zones may. It is noted that anywhere from one to all zones of the mat 10 may have sensors in various configurations. It is further noted that the mat 10 may comprise a different number of zones.

In an aspect, sensors may connect in a wired or wireless fashion to at least a portion of smart mat component 300 attached to or incorporated as a part of the mat 10. The processor may analyze the data provided by the sensors. In one embodiment, the control component 330 may communicate with other components, such as a mobile component 307 that may analyze and control display of the data transferred from the sensors. The mobile component 307 may be an application configured for computer execution and may be what is commonly referred to as an “app”. The mobile component 307 may be run on a computer, a cell phone, a laptop, a tablet, a smart phone, wearable device, or a similar electric device. The processor may connect to the electronic device via USB cable, Ethernet cable, Wi-Fi, Wi-Fi direct, BLUETOOTH™, Zigbee, other 802.XX wireless technologies, or any other appropriate communication means.

In one embodiment, for example, a user may position himself on an exercise mat with both his hands and his feet positioned on the mat, with all for appendages exerting pressure on various sensors. A computer application may receive pressure data from sensors mapped to specific coordinates on the mat through BLUETOOTH™, or a wireless connection. The data may be delivered in any appropriate format, for example JSON (e.g., {{x:1, y:2, val: 100.23}, {x:2, y:2, val. 99.32}}). The mobile component 307 may then use the transferred data to determine if the combined image corresponds or correlates to a pre-defined pose within the app's database or to determine if a particular area of pressure corresponds to a specific body part identified within the app's database using a recognition framework. For example, the app's database may contain information on standard yoga poses, e.g., downward dog, as well as information on body parts corresponding with certain collections of adjacent coordinates with corresponding pressure values identified by the sensors.

The mobile component 307 may utilize open image recognition frameworks such as DeepBeliefSDK, Neuroph, or any other appropriate open or proprietary frameworks or other programs to analyze data from the sensors. The mobile component 307 may analyze sensory data, and, using a set of pre-defined formulas, calculate the distances between areas of pressure on the mat to determine the distance between the user's limbs on the mat. For example, the mobile component 307 may determine that the user's left hand is 16 inches away from the user's right hand, and that the hands are parallel in placement. Similarly, the mobile component 307 may determine that the user's feet are located close together and are within 140 cm from the user's hands. The mobile component 307 may be able to convert the limb distances into a ratio, e.g., the hands are at a ratio of 1:0.8 the height of the user away from the feet. Additionally, the mobile component 307 may also be able to locate the actual position of the limbs in relation to the edges of the mat. In another aspect, the mobile component 307 may be configured to receive data associated with pressure, changes in pressure, weight, position and/or time. The mobile component 307 may make inferences based on weighted averages, or the like.

In an aspect, the control component 330 and/or a mobile component 307 (as well as other components of system 300) may utilize artificial intelligence, statistical models, or other processes and/or algorithms. In embodiments, mobile component 307 may utilize classifiers that map an attribute vector to a confidence that the attribute vector belongs to a class. For instance, mobile component 307 may input attribute vector, x=(x₁, x₂, x₃, x₄, xᵢ) mapped to f(x)=confidence(class). Such classification can employ a probabilistic and/or statistical-based analysis (e.g., factoring into the analysis affinities and ingredient attributes) to infer a position of a user's limbs or the like. In various embodiments, mobile component 307 may utilize other directed and undirected model classification approaches, such as, e.g., naïve Bayes, Bayesian networks, decision trees, neural networks, fuzzy logic models, and probabilistic classification models providing different patterns of independence. Classification may also include statistical regression that is utilized to develop models of priority.

In accordance with various aspects of the subject specification, an example embodiment may employ classifiers that are explicitly trained (e.g., via a generic training data) as well as implicitly trained (e.g., via observing user behavior, user preferences, historical information, receiving extrinsic information). For example, support vector machines may be configured via learning or training phase within a classifier constructor and feature selection module. Thus, the classifier(s) may be used to automatically learn and perform a number of functions, including but not limited to determining exercise routines, user identities, target goals for dietary or fitness needs, and the likes. This learning may be on an individual basis, i.e., based solely on a single user, or may apply across a set of or the entirety of the user base. Information from the users may be aggregated and the classifier(s) may be used to automatically learn and perform a number of functions based on this aggregated information. The information may be dynamically distributed, such as through an automatic update, a notification, or any other method or means, to the entire user base, a subset thereof or to an individual user.

In one embodiment, the mobile component 307 may use the information determined about the placement of the user's limbs and cross-reference it with data pre-downloaded in a local database to determine what position the user is attempting. The local database may contain base line ratios derived from yogis of varying heights and weights. The user's pre-saved height and weight may be used to match the user with the base line positioning of a similarly-sized yogi in the database. Alternatively, a user may be able to retrieve additional information from a remote server to identify a better match for the user's data. The remote server may hold a full database which increases in accuracy with user-generated curated data which the users' data is also added to unless the user chooses to opt out. A user may send his data, which may include an on-app analysis, to see if any other users have tagged the same or similar coordinates on the mat 10. The user may then be matched with at least one yogi in the full database. Alternatively, if a yogi match is not available using the remote server, the user may be able to enter his data for the unknown position into the full database for later use.

User data, which may include specific coordinates of the user on the mat 10, may be saved in the local database of the mobile component 307. Then the mobile component 307 may perform various analyses, including a time-lapse analysis of the user's poses, i.e., an analysis comparing the user's pose to the more ideal pose by the yogi, and aggregate values for the particular pose to add to an aggregate database for data improvement of the full database.

Based on the results determined in the analysis of the user's poses, the mobile component 307 may provide feedback or suggest corrections based on a set of data for a more ideal weight distribution stored in the full database from yogis' measurements. For example, if a user is in a particular pose where the mat receives and sends a signal that 50% of the pressure is on his hands, and of that pressure, 45% of the pressure is on his left hand and 55% is on his right hand, and the more ideal pose weight distribution advises 45% of the user's weight should be split equally between his hands and 55% split equally between his feet, the mobile component 307 may suggest that the user push back onto his legs a slight amount and lean his upper body slightly to the left to achieve the desired position. The mobile component 307 may suggest improvements or modifications via aural or written feedback. Alternatively, the mat may provide visual feedback in the form of a color scale or spirit level to indicate the proximity of the user's position to the correct position. It is noted that the mobile component 307 may comprise user instructions, a memory storing the user instructions, and a processor configured to execute the user instructions.

In addition to the limb placement measurements discussed above, a user's arm and feet span, as well as his Ape index, i.e., the measure of a user's individual arm span relative to the user's height may be used with the more ideal pose weight distribution guide to advise the user.

In one aspect of the technology, an exercise mat may be used with gaming consoles, massively multiplayer online games, interactive classes, the internet, cell phone technologies, social networks, and so forth as a fitness-based music and entertainment device. This version of the mat may be based on body measurements and proper positioning on timed systems and with biofeedback loops. The mats may comprise weight sensors, which can aid in facilitating balance and proper alignment. For example, with the downward dog yoga position, the user is on his hands and feet and his coccyx is moving up and back toward the ceiling while his heels descend toward the floor. The weight sensitive measures can instruct and provide feedback for the user on where the weight is distributed and which direction he/she should redistribute weight. In the downward dog pose example, more weight should be distributed in the feet and legs and less in the arms, thus relieving weight burdens on and preventing overstretching in the shoulders.

Additionally, the mats may be coupled with one or more of warning devices, light emitting diodes (LEDs), memory devices, associated speakers, sound and speech synthesizers, audio/video feedback, realignment sensors, heart rate monitors, pulse monitors, gyroscopic sensors, or voice guidance to correct postures based on body measurements including height and weight, weight distribution, heart rate, length and timing of posture held, position of the user's upper body which may not be in contact with the mat, and timing of breath. Furthermore, provisions can be made for reading of directional movement including spiral movements of energy lines (meridians) through the body (nadis); lifting and alignment of bones and skeletal structure, musculature, the pelvis, shoulders, spine, vertebrae, vertebral column, and biofeedback and instruction can be provided based thereon. The systems may further provide measurement of vital signs and brain frequency to give biofeedback on meditative state, including responsive light or audio guidance or voice guidance for breath control, programs for breath control techniques to change brain/meditative frequencies, and deep relaxation and de-stress techniques, programs and control systems.

The timing and biofeedback systems may, for example, instruct the user on how long to hold a pose while also correlating the length held with the rhythm and timing of the breath. Breathing is a fundamental and important guideline to physical movement, bodily awareness, and mind-body control. Biofeedback systems may also provide feedback on biorhythms and functions of the body such as heart rate. The biofeedback systems may also assist with mental focus while training. Machine generation of original flow sequencing and programming can also be based upon the user's level of physical capability, performance, and increases/improvements in skill, flexibility, agility, strength, overall health, and brain function.

In at least one embodiment, the mat 10 may also be linked to systems such that movement or weight placement on various positions of the mat result in audio or visual response that is not instruction-related. In this way, the combination of symbols on the mat's surface and the touch-sensitive, timed-response feedback loop with auditory and graphic feedback create an experience where the user creates a fitness-based interactive music and entertainment experience. For example, via movement and weight placement, a user can essentially become an instrument or music artist.

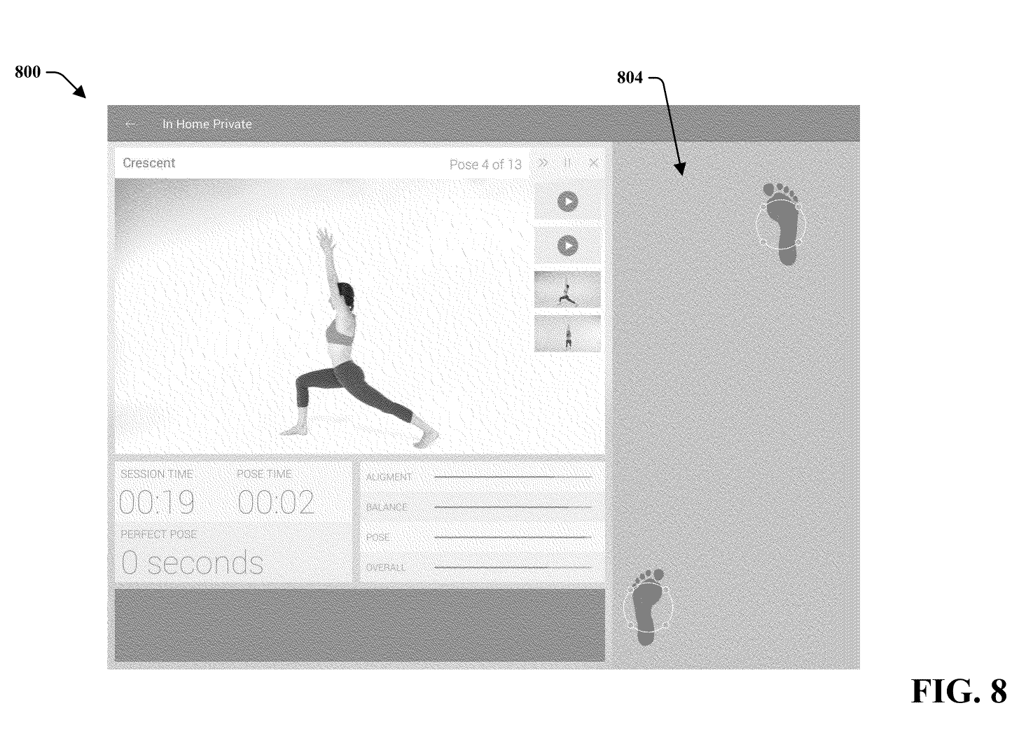

In another embodiment, the mobile component 307 associated with the mat may display a balance-board type image (e.g., balance board 804 of FIG. 8). The balance-board image may assist a user in seeing his movements and balance in real time and allow the user to better visualize corrections. It is noted that the balance-board image may include renderings of a user's limbs and/or information regarding the sensor information.

In yet another embodiment of the technology, the mobile component 307 may provide guided yoga classes, either through audio or visual technologies, which allow for real time feedback and corrections to the user through the class. Additionally, in a class or in an individual practice, the mobile component 307 may store a history of the user's yoga practice and assign “scores” to each movement and position based on the “correct” position information provided by yogis. These scores and other information may be shared through social media and gamification uses of the app.

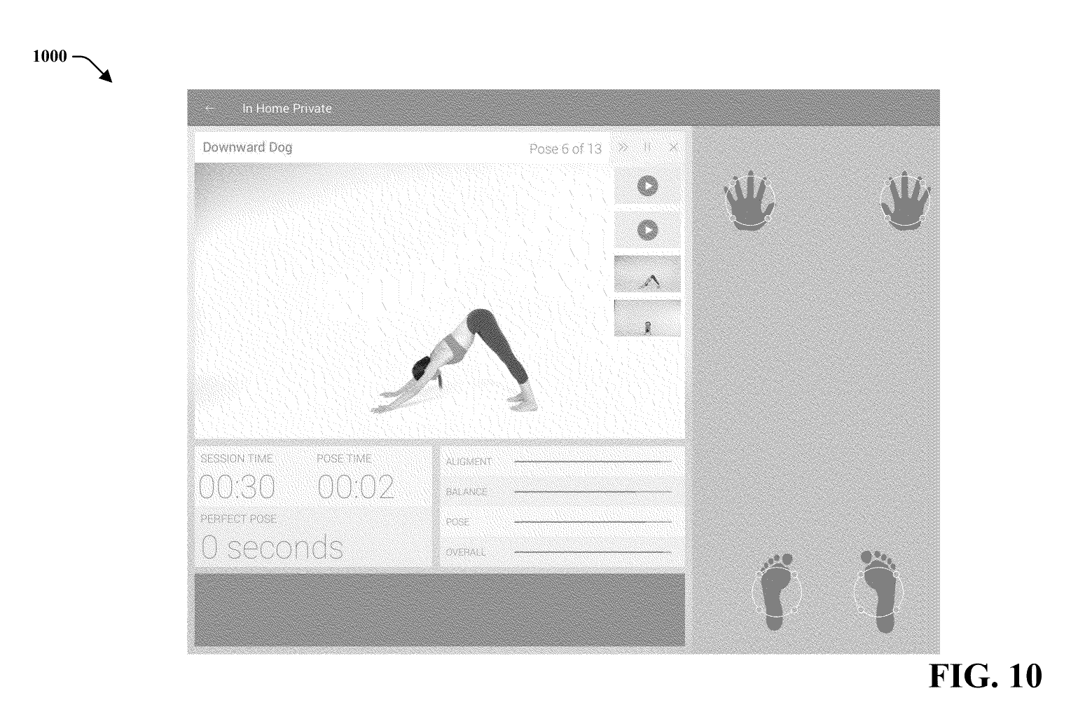

In another embodiment of the technology, the user can simply record their movements in silent (Zen) mode, as shown in rendering 1000 of FIG. 10, and review a time-lapse history of one or multiple practices. One example is a speeded up manner of one workout (for example, reviewing a 60 minute workout in 3 minutes by speeding through accurate parts and focusing on errors to correct). Another example is a time-lapse of a certain pose through multiple practices (for example, comparing the improvement of a user's downward dog pose across 60 workouts spanning 30 days).

It is noted that system 300 may include other devices that may be utilized with the various described aspects. For instance, the system 300 may communicate with a wearable electronic device that may monitor a user's heartbeat, breathing, or other biological information. The biological information may be received by system 300 and may be analyzed and/or stored. In an example, the biological information may be utilized to determine statistics associated with exercises, monitor safety, or the like.

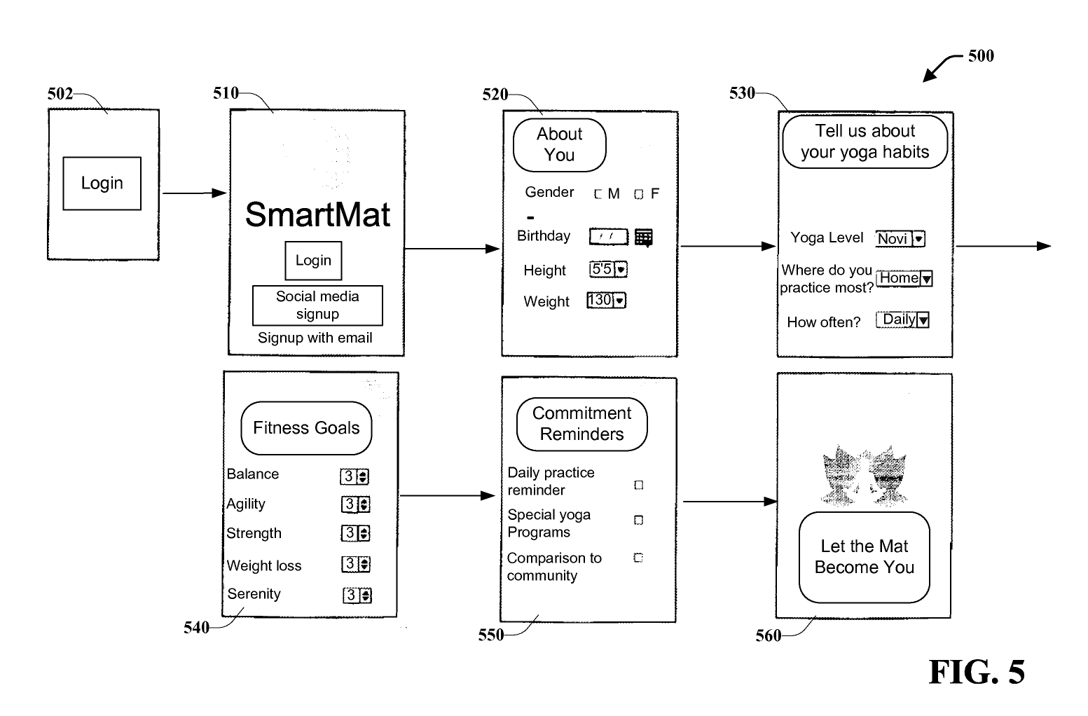

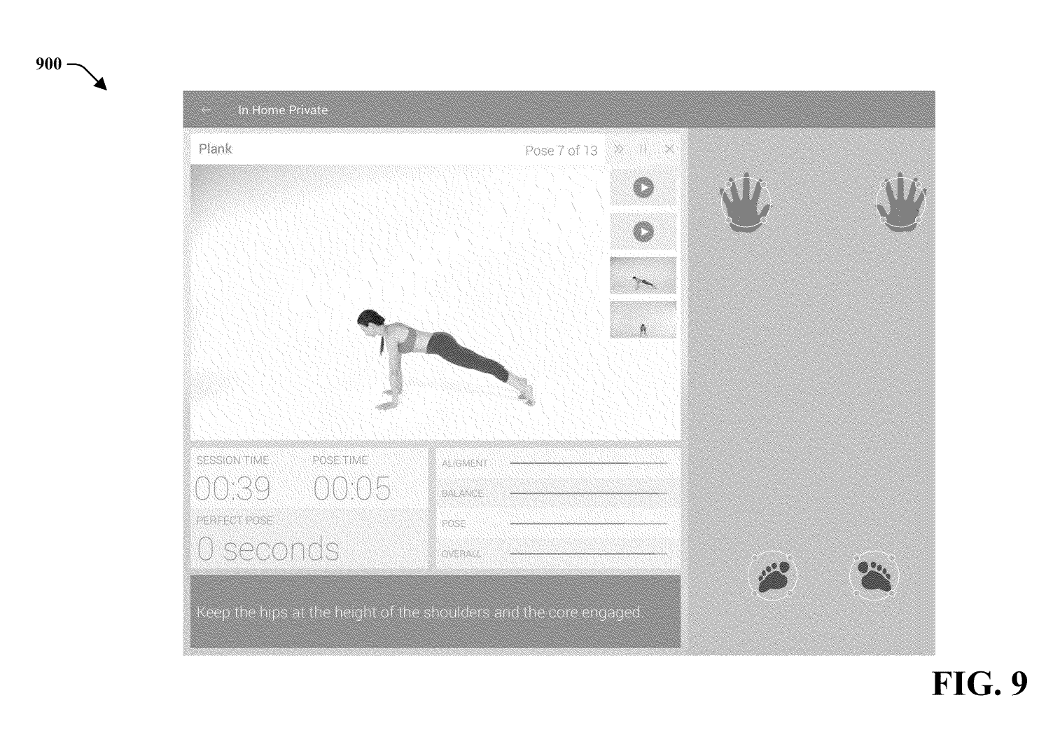

Turning to FIGS. 5-9, illustrated are exemplary methods and/or renderings according to various disclosed embodiments. For instance, FIG. 5 may comprise a login or registration process 500 associated with a smart mat system. In an aspect, mobile component 307 may be configured to instruct a display to render various images or screens depicted in FIG. 5. While examples may describe a user action, it is appreciated that a user may or may not be required to provide input. In an aspect, providing input may include a mobile component 307 receiving the input from a user, another device, memory, or the like. For sake of brevity, examples are described with reference to user actions, however, it is noted that the user may not be required to perform actions.

At reference number 502, a user may initiate a login process by selecting a login control. At 510, a user may select to register a new account or sign in with an existing account, such as a social network account. At 520, mobile component 307 may render an image (e.g., including controls or input fields) to receive user information, such as statistical data of a user (e.g., birthday, height, weight, gender, left/right handedness, or the like). At 530, mobile component 307 may render an image and/or fields regarding a user's exercise history and preferences. At 540, mobile component 307 may render an image and/or fields regarding a user's fitness goals. At 550, mobile component 307 may render an image and/or fields regarding a user's desired level of commitment (e.g., daily, weekly, etc.). At 560, mobile component 307 may render an image and/or fields to allow a user to save or confirm registration process 500.

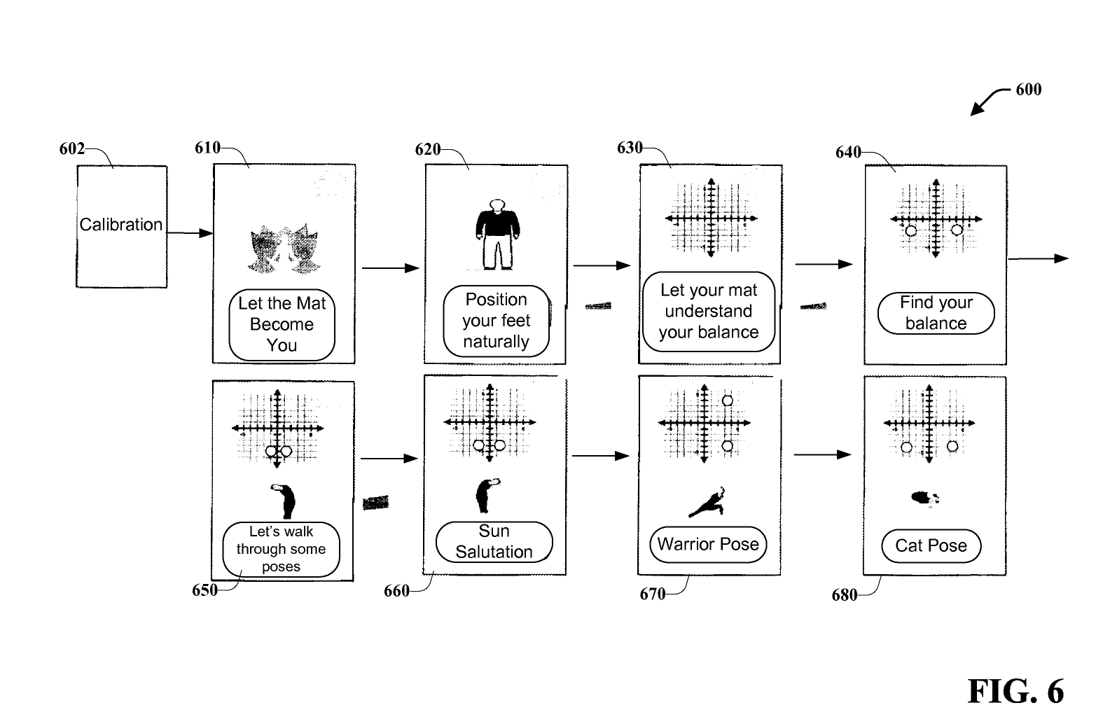

FIG. 6 illustrates an exemplary calibration process 600 and/or renderings of a display device during calibration process 600. At 602, a mobile component 307 may render (e.g., via an interface device) an image to indicate that a calibration process is available, beginning, and/or may be utilized by a user. At 610, mobile component 307 may render an image and/or fields indicating that a calibration process is beginning. At 620, an initial calibration instruction is displayed. In an aspect, a user may utilize mat 10 to perform various acts for the calibration process 600. At 630, a system can instruct the user to position themselves on the mat 10. In an aspect, system 300 may receive sensor information from mat 10 to determine a position, pressure, and/or balance of a user. The balance may be displayed at 640. In another aspect, the system 300 may receive other information associated with poses for a yoga session, as shown at 650, 660, 670 and 680. It is noted that the system 300 may receive the information and may calibrate sensors and/or input for future lessons/exercises based on the calibration process 600.

As described herein, the smart mat system 300 may be configured for various exercise programs and/or uses. For instance, the smart mat system 300 may be configured for in-home mode, practice mode, in-class mode, Zen-mode, or the like. In the in-home mode, a user may perform an exercise routine on their own. In the in-class mode, the user may be instructed by a yogi or may perform routines with others, such as friends on a social network. In the Zen-mode, the user may perform any exercise they desire, and the system may monitor the exercises and may record the exercises for review and/or later user.

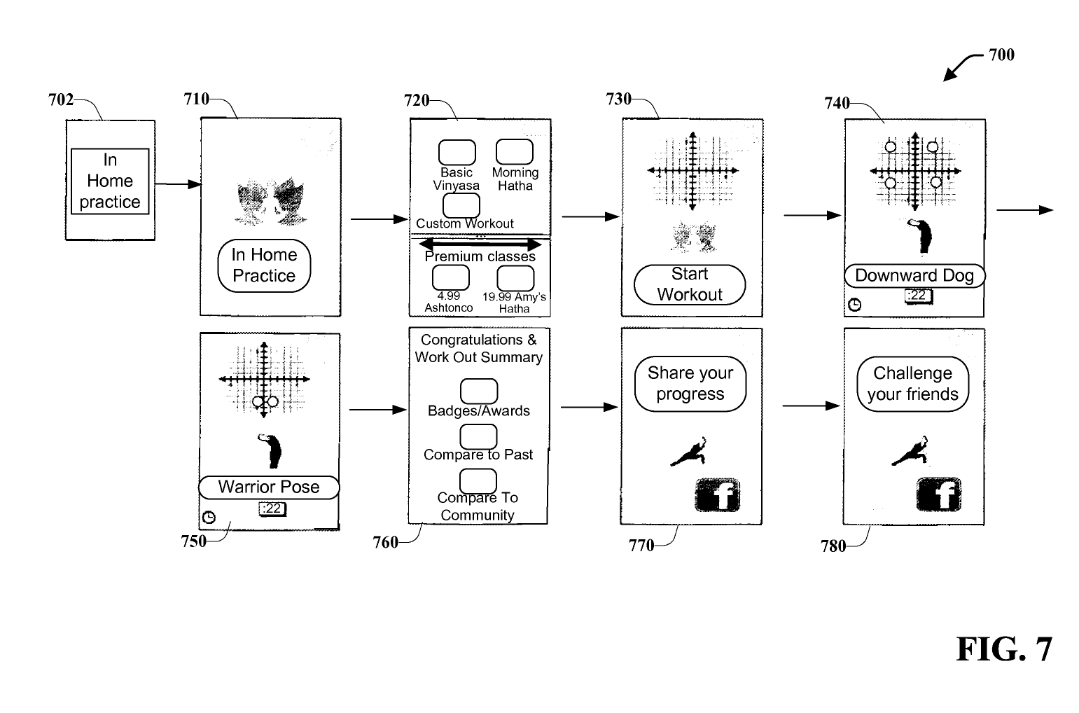

Turning now to FIGS. 7-10, there depicted are exemplary renderings of process and/or renderings associated with an in-home mode 700. FIG. 7 depicts a set of renderings 702, 710, and 720 that may allow a user to select a workout from a set of predetermine workouts and/or create a custom workout. In another aspect, a user may be able to select free classes, previously purchased classes, or may purchase other classes, such as premium classes, as shown at reference number 720. At 730, a user may select to start a workout. At 740 and 750, the system may instruct the user to perform various activities and may receive sensor data associated with the activities. It is noted that an exercise routine may comprise different numbers of activities and different times associated with the activities. In an aspect, the mobile component 307 may provide information to a user, such as a time remaining, time past, amount of time a user has been in a correct or ideal position, scores for a pose (e.g., alignment, balance, pose, overall or weighted, etc.), demonstrations (e.g., video, images, audio), or the like. Further, the mobile component 307 may provide information in the form of a balance board that represents the user's yoga mat and the position and pressure distribution of a user. Various aspects are described in FIGS. 8-10, which depict renderings 800, 900, and 1000.

The balance board 804 may comprise a rendering of limbs or body parts that should be and/or are in contact with the mat 10. In an aspect, the renderings of the body parts may include information that represents a pressure distribution. For instance, portions of the renderings may comprise different colors that represent weight distribution. In an example, a red color may mean that weight or pressure is not received at a particular point, and a green color may mean that pressure is received. A user may try to balance or adjust their weight such that all the portions are green. In another aspect, colors may represent whether a user is outside of a threshold range of pressure.

At 760, the system may render a summary of a workout or session. The summary may include historical information that compares a current workout with past workouts, comparisons with workouts of others (e.g., friends on a social network), or the like. In another aspect, the user may be awarded with progress badges or points. At 770, the system may allow a user the option to share their progress and/or results of their workout. According to an embodiment, the user may challenge friends (e.g., friends on a social network) to perform exercises at 780. It is noted that sharing of information may be disabled or may be prevent unless a user provides authorization for such sharing. Likewise, personal information may be retained private. This sharing may also include ratings from exercises. The ratings may be shared with a yogi or exercise program designer based upon this feedback.

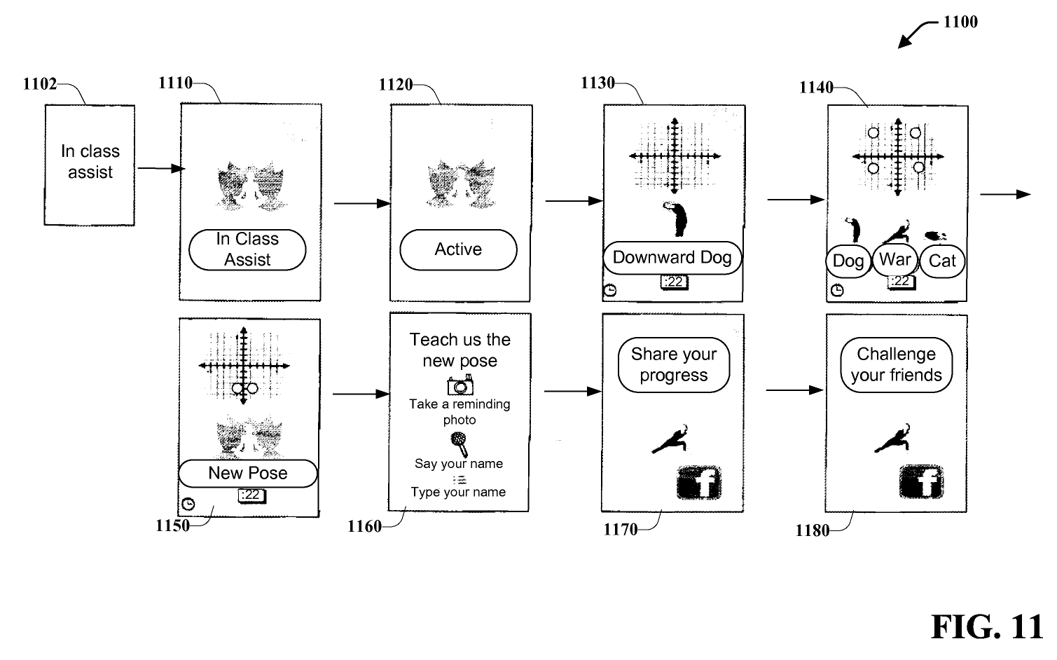

FIGS. 11-13 are exemplary renderings of process and/or renderings associated with an in-class mode 1100. In the in-class mode, the user may perform activities with others, such as other students, instructors, or the like. It is noted that the other users may be in the same physical room or may be in other locations, and may be associated with other user devices. In an example, users may be in their own homes and may communicate with an instructor and/or each other via a communication framework (e.g., wireless or wired networks).

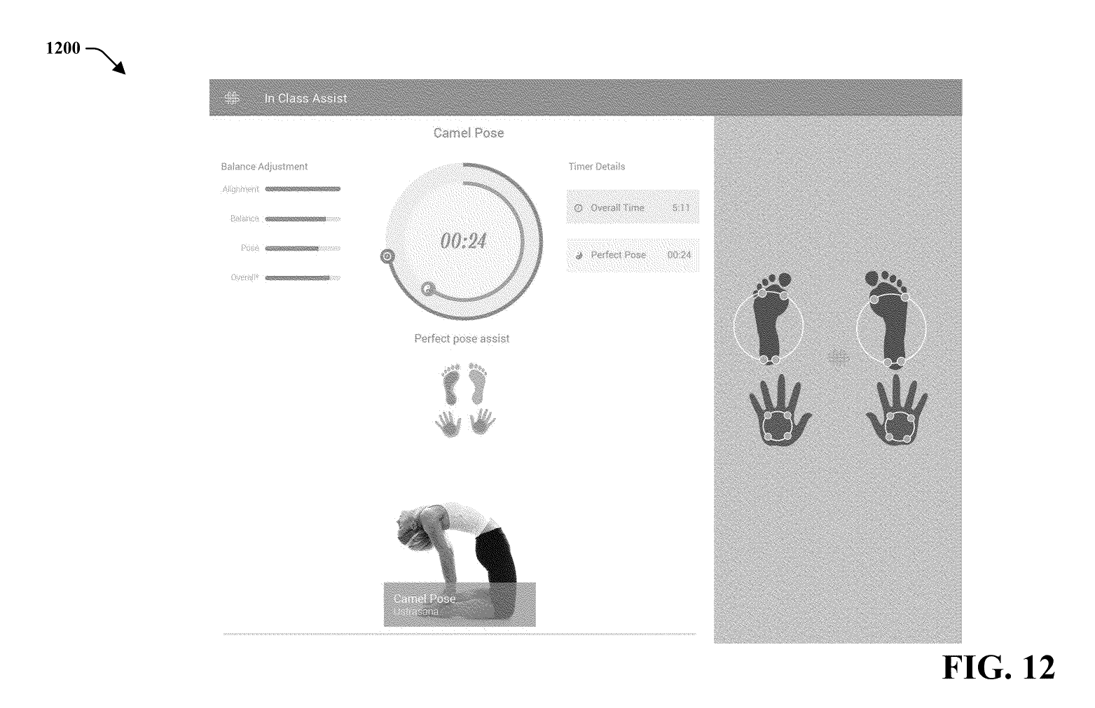

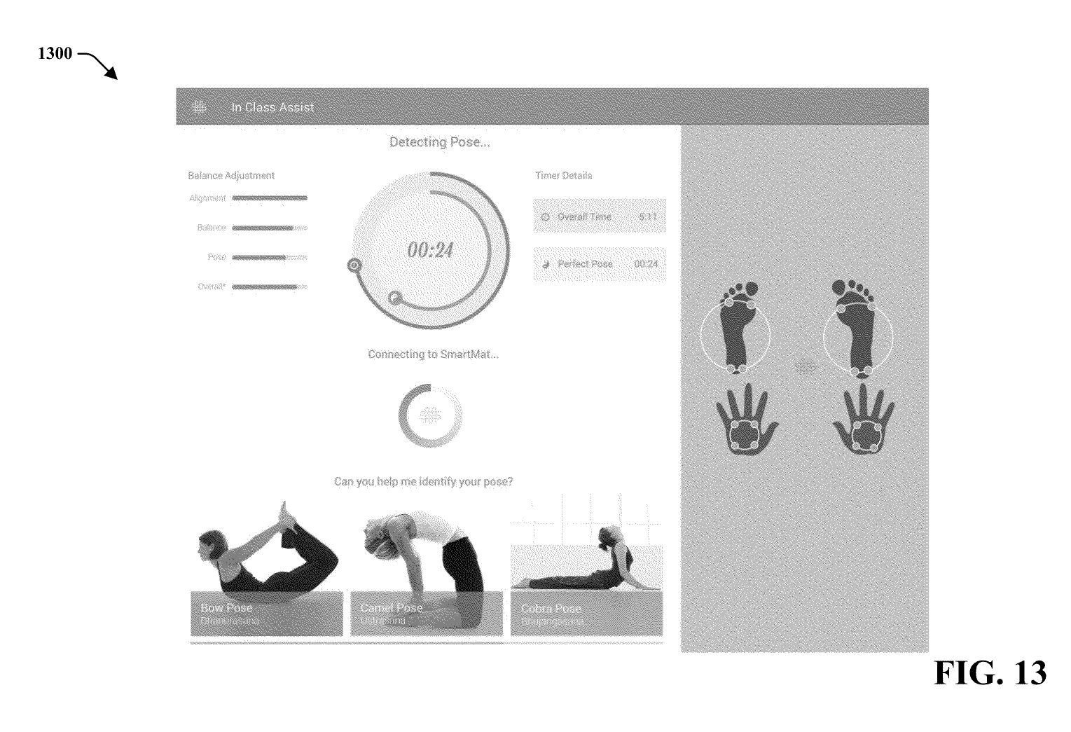

A user may initiate an in class session at 1102, 1110, and/or 1120. In an aspect, a user may be placed in a waiting room while others join, may join an in-progress session, and/or may start the session. During the session, a user may perform various activities and the smart mat system 300 may receive sensor information and provide feedback as shown at 1130, 1140, and FIGS. 12-13. At 1150 and 1160, a user may create a new pose and may share the pose with others in the class. In an aspect, the user may create the pose from an existing pose, via textual instructions, video, audio, still images, drawings, or the like. It is noted that the user may set locations of limbs and/or sensor information (e.g., weight distribution) for ideal poses. At 1170 and 1180, the user may share progress and/or challenge friends on a social network.

As depicted in FIGS. 12-13, a system may render various tools and images for assisting a user during their exercise routine. In an aspect, the system may determine whether the user is in a perfect or ideal pose based on sensor information. The system may share this information with the user via text, images, or the like. Likewise, the system may provide timer information, information about a pose, information about a user's progress and/or acts that may be made to improve a pose. An ideal pose may be associated with a weight distribution, balance, or other metric that is derived from sensors of system 300. It is noted that the metrics may be set based on predetermined thresholds, user-determined thresholds, and/or based on information received from other users, such as instructors or yogis.

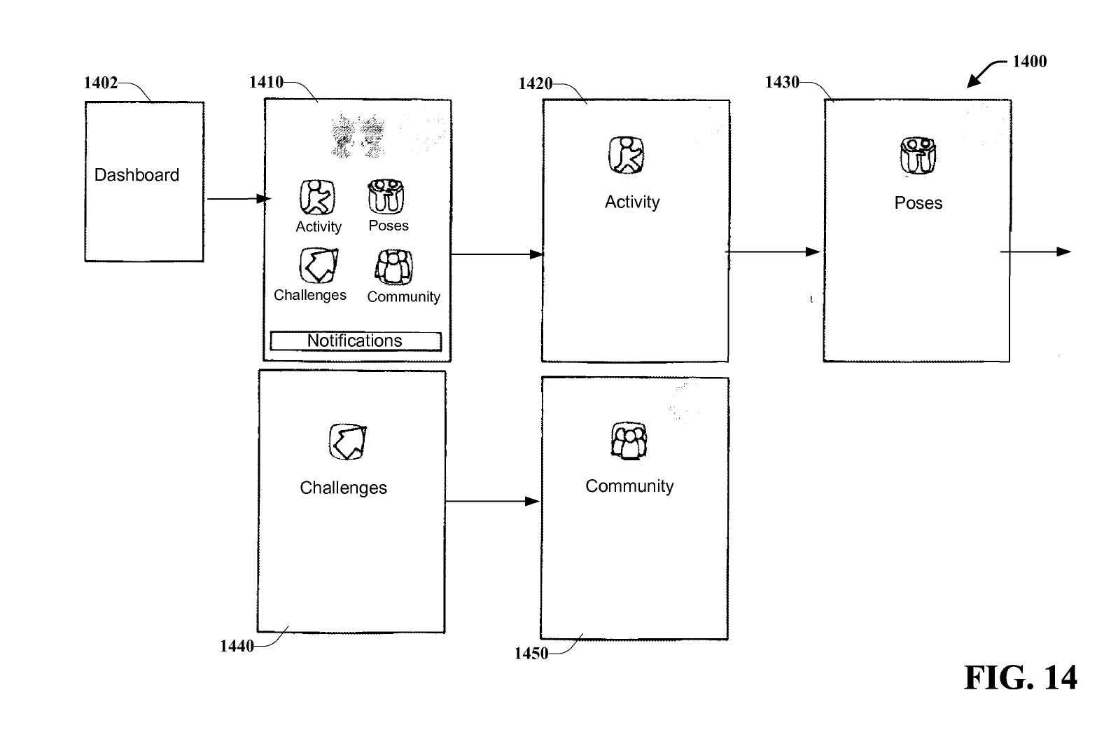

FIG. 14 illustrates exemplary renderings of process and/or renderings associated with non-class or exercise activities 1400. For instance, a home page 1410 may include links or instructions that allow a user to access poses 1430, historical data (e.g., time logs, exercise progress, etc.) 1420, community or social networking options 1450, challenges from users and/or issued to users 1440, and the like.

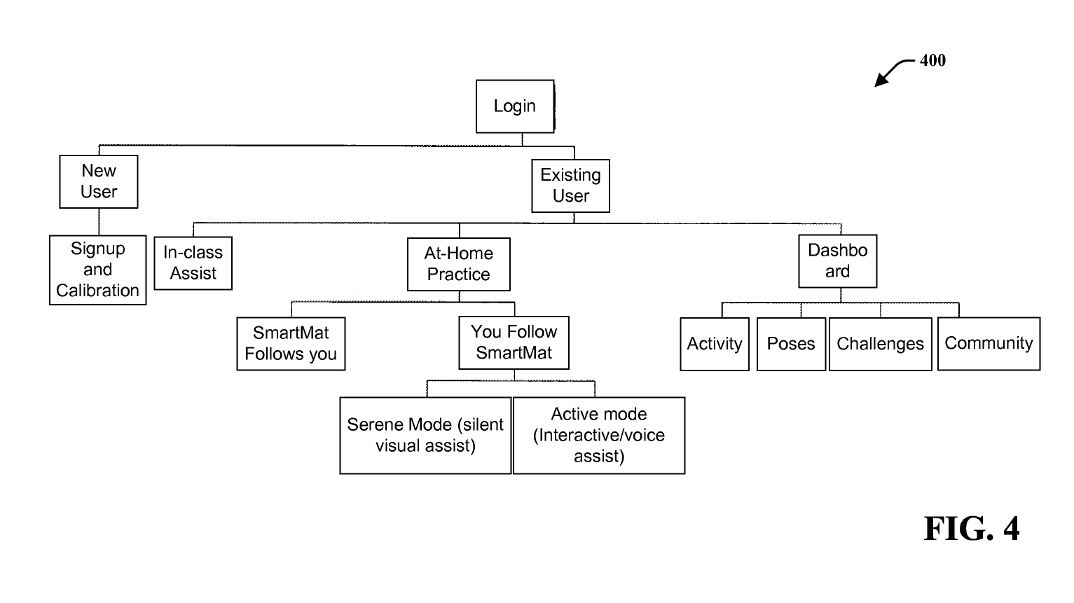

FIG. 4 is a flow diagram 400 of acts or processes associated with various aspects of the smart mat system described herein. As depicted, the smart mat system may be organized in a number of modes. In each mode, a user may have a number of options which they may utilize.

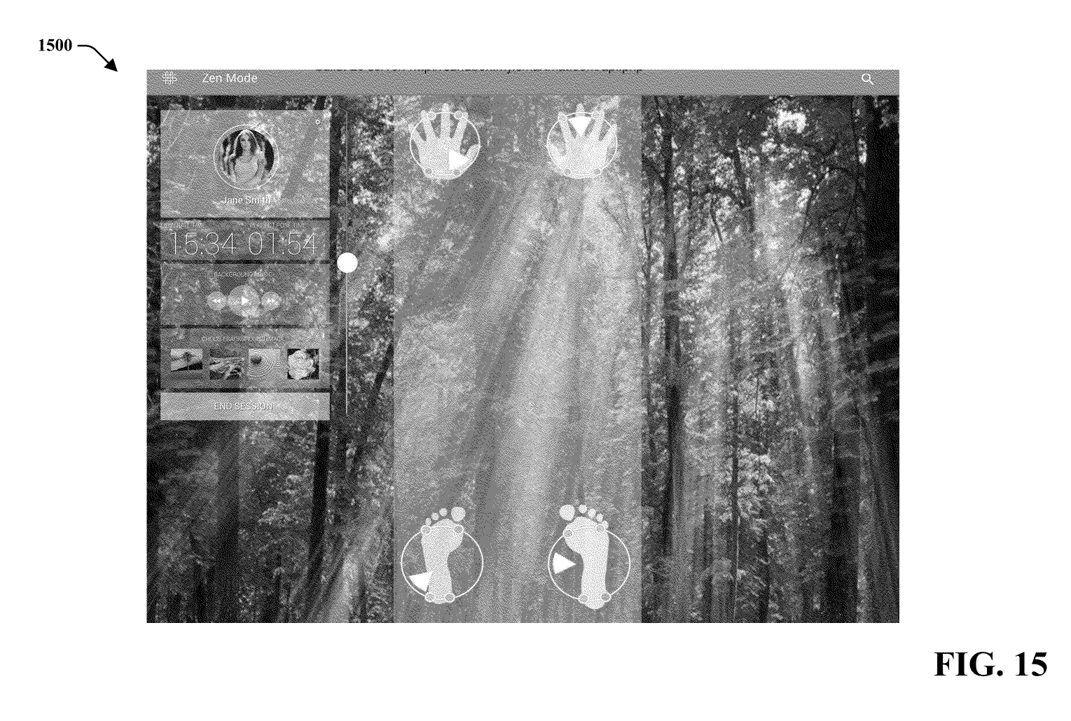

FIG. 15 is an exemplary rendering of a Zen-mode 1500 or free flow mode. In the Zen-mode 1500, a user may play desired background music, perform any exercise, and the system may monitor and/or record their exercises. In an aspect, the Zen-mode 1500 may include a rendering of a balance board and information associated with pressure of and/or balance. The rendering may include time information and/or options/controls associated with exercise. In another aspect, the user may select images for a background of the rendering.

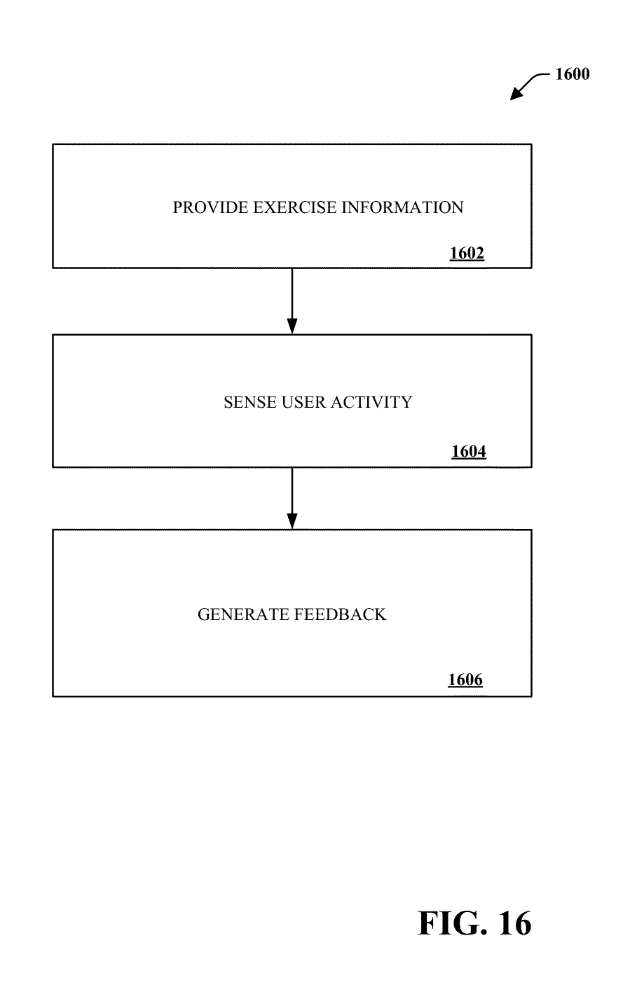

In view of the subject matter described herein, methods that may be related to various embodiments may be better appreciated with reference to the flowchart of FIG. 16. While the methods are shown and described as a series of blocks, it is noted that associated methods or processes are not limited by the order of the blocks. It is further noted that some blocks and corresponding actions may occur in different orders or concurrently with other blocks. Moreover, different blocks or actions may be utilized to implement the methods described hereinafter. Various actions may be completed by one or more users, mechanical machines, automated assembly machines (e.g., including one or more processors or computing devices), or the like.

At 1602, a system (e.g., smart mat system 300) may provide exercise information to a user. The information may include routines, modes, or the like. It is noted that the information may be provided via images, video, audio, or the like.

At 1604, the system may sense user activity. For instance, mat 10 may sense a user's limbs or body parts, pressure, movement, or the like. The sensed activity may be received by a processor, user device, or the like. At 1608, the system may generate feedback. The feedback may include information associated with a user's balance, pose, or other information. It is noted that various other acts and/or aspects described above may be included in the various blocks or actions of method 1600.

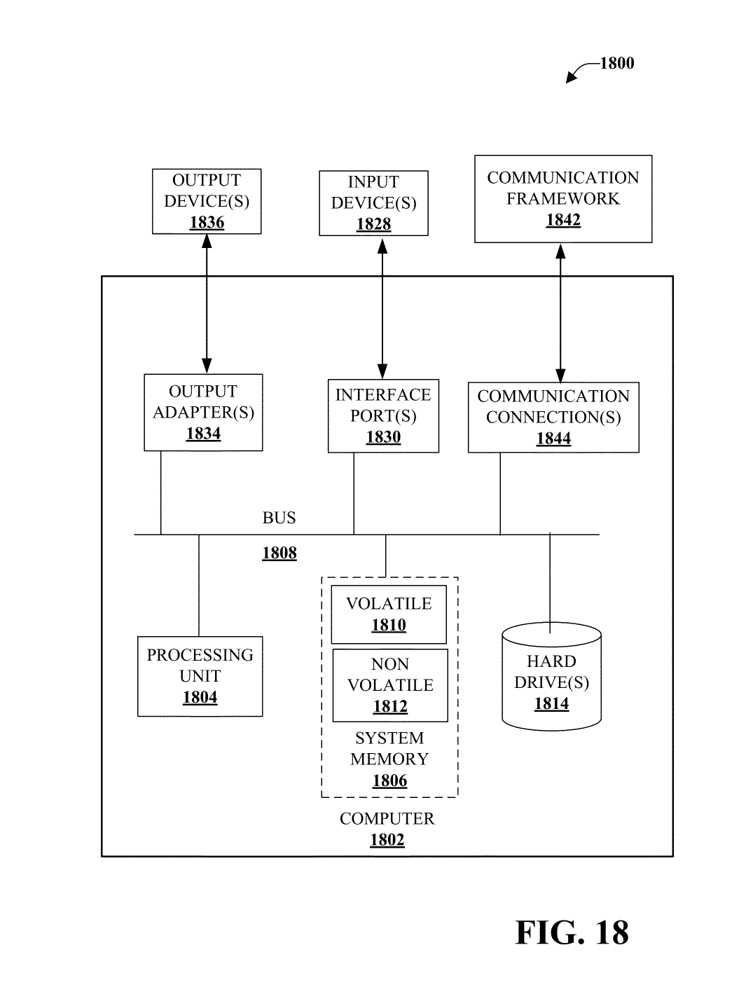

What has been described above may be further understood with reference to the following figures. FIGS. 17 and 18 provide exemplary operating environments or systems capable of implementing one or more systems, apparatuses, or processes described above. FIGS. 17 and 18 are not intended to limit the scope of such systems, apparatuses, or processes. By way of example, computing environment 1700 may refer to one or more embodiment of the various embodiments described with reference to the above figures. However, variations to computing environment 1700 may be obvious to achieve aspects or processes described herein.

FIG. 17 is a schematic diagram of a computing environment 1700 in accordance with various disclosed aspects. It is noted that computing environment 1700 may include various other components or aspects. As depicted, computing environment 1700 may include one or more client(s) 1702, one or more server(s) 1704, one or more client data store(s) 1720, one or more server data store(s) 1710, and a communication framework 1706.

While depicted as a desktop computer(s), client(s) 1702 may include various other devices that may comprise hardware and/or software (e.g., program threads, processes, computer processors, non-transitory memory devices, etc.). In an example, client(s) 1702 may include laptop computers, smart phones, tablet computers, wearables, etc.). The client(s) 1702 may include or employ various aspects disclosed herein. For example, client(s) 1702 may include or employ all or part of various systems and processes disclosed herein.

Likewise, server(s) 1704 may include various devices that may comprise hardware and/or software (e.g., program threads, processes, computer processors, non-transitory memory devices, etc.). Server(s) 1704 may include or employ various aspects disclosed herein. For example, server(s) 1704 may include or employ all or part of various systems and processes disclosed herein. It is noted that server(s) 1704 and client(s) 1702 may communicate via communication framework 1706. In an exemplary communication, client(s) 1702 and server(s) 1704 may utilize packeted data (e.g., data packets) adapted to be transmitted between two or more computers. For instance, data packets may include coded information associated with exercise routines or the likes.

Communication framework 1706 may comprise various network devices (e.g., access points, routers, base stations, etc.) that may facilitate communication between client(s) 1702 and server(s) 1704. It is noted that various forms of communications may be utilized, such as wired (e.g., optical fiber, twisted copper wire, etc.) and/or wireless (e.g., cellular, Wi-Fi, near field communication, etc.) communications.

In various embodiments, client(s) 1702 and server(s) 1704 may respectively include or communicate with one or more client data store(s) 1720 or one or more server data store(s) 1710. The data stores may store data local to client(s) 1702 or server(s) 1704.

In at least one embodiment, a client of client(s) 1702 may transfer data describing an exercise, user account data, ratings, or the likes to a server of server(s) 1704. The server may store the data and/or employ processes to alter the data. For example, the server may transmit the data to other clients of client(s) 1702.

FIG. 18 is a block diagram of a computer system 1800 that may be employed to execute various disclosed embodiments. It is noted that various components may be implemented in combination with computer executable instructions, hardware devices, and/or combinations of hardware and software devices that may be performed by computer system 1800.

Computer system 1800 may include various components, hardware devices, software, software in execution, and the likes. In embodiments, computer system 1800 may include computer 1800. Computer 1800 may include a system bus 1808 that couples various system components. Such components may include a processing unit(s) 1804, system memory device(s) 1806, disk storage device(s) 1814, sensor(s) 1835, output adapter(s) 1834, interface port(s) 1830, and communication connection(s) 1844. One or more of the various components may be employed to perform aspects or embodiments disclosed herein. In an aspect, the computer system 1800 may “learn,” such as described above user preferences based upon modifications of exercises, feedback associated with satisfaction, or the like. For example, the computer system 1800 may modify a particular exercise routine (or a set thereof) as a number of users have disapproved of the exercise. The computer system 1800 may dynamically push out the revised exercises or receive the revised exercises as applicable.

Processing unit(s) 1804 may comprise various hardware processing devices, such as single-core or multi-core processing devices. Moreover, processing unit(s) 1804 may refer to a “processor,” “controller,” “computing processing unit (CPU),” or the likes. Such terms generally relate to a hardware device. Additionally, processing unit(s) 1804 may include an integrated circuit, an application-specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or the likes.

System memory 1806 may include one or more types of memory, such volatile memory 1810 (e.g., random access memory (RAM)) and non-volatile memory 1812 (e.g., read-only memory (ROM)). ROM may include erasable programmable ROM (EPROM), electrically erasable programmable ROM (EEPROM). In various embodiments, processing unit(s) 1804 may execute computer executable instructions stored in system memory 1806, such as operating system instructions and the likes.

Computer 1802 may also be one or more hard drive(s) 1814 (e.g., EIDE, SATA). While hard drive(s) 1814 are depicted as internal to computer 1802, it is noted that hard drive(s) 1814 may be external and/or coupled to computer 1802 via remote connections. Moreover, input port(s) 1830 may include interfaces for coupling to input device(s) 1828, such as disk drives. Disk drives may include components configured to receive, read and/or write to various types of memory devices, such as magnetic disks, optical disks (e.g., compact disks and/or other optical media), flash memory, zip drives, magnetic tapes, and the likes.

It is noted that hard drive(s) 1814 and/or other disk drives (or non-transitory memory devices in general) may store data and/or computer-executable instructions according to various described embodiments. Such memory devices may also include computer-executable instructions associated with various other programs or modules. For instance, hard drives(s) 1814 may include operating system modules, application program modules, and the likes. Moreover, aspects disclosed herein are not limited to a particular operating system, such as a commercially available operating system.

Input device(s) 1828 may also include various user interface devices or other input devices, such as sensors (e.g., microphones, pressure sensors, light sensors, etc.), scales, cameras, scanners, facsimile machines, and the likes. A user interface device may generate instructions associated with user commands. Such instructions may be received by computer 1802. Examples of such interface devices include a keyboard, mouse (e.g., pointing device), joystick, remote controller, gaming controller, touch screen, stylus, and the likes. Input port(s) 1830 may provide connections for the input device(s) 1828, such as via universal serial ports USB ports), infrared (IR) sensors, serial ports, parallel ports, wireless connections, specialized ports, and the likes.

Output adapter(s) 1834 may include various devices and/or programs that interface with output device(s) 1836. Such output device(s) 1836 may include LEDs, computer monitors, touch screens, televisions, projectors, audio devices, printing devices, or the likes.

In embodiments, computer 1802 may be utilized as a client and/or a server device. As such, computer 1802 may include communication connection(s) 1844 for connecting to a communication framework 1842. Communication connection(s) 1844 may include devices or components capable of connecting to a network. For instance, communication connection(s) 1844 may include cellular antennas, wireless antennas, wired connections, and the likes. Such communication connection(s) 1844 may connect to networks via communication framework 1842. The networks may include wide area networks, local area networks, facility or enterprise wide networks (e.g., intranet), global networks (e.g., Internet), satellite networks, and the likes. Some examples of wireless networks include Wi-Fi, Wi-Fi direct, BLUETOOTH™, Zigbee, and other 802.XX wireless technologies. It is noted that communication framework 1842 may include multiple networks connected together. For instance, a Wi-Fi network may be connected to a wired Ethernet network.

The terms “component,” “module,” “system,” “interface,” “platform,” “service,” “framework,” “connector,” “controller,” or the like are generally intended to refer to a computer-related entity. Such terms may refer to at least one of hardware, software, or software in execution. For example, a component may include a computer process running on a processor, a processor, a device, a process, a computer thread, or the likes. In another aspect, such terms may include both an application running on a processor and a processor. Moreover, such terms may be localized to one computer and/or may be distributed across multiple computers.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Each of the components described above may be combined or added together in any permutation to define the described systems. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Although the embodiments of the present technology have been illustrated in the accompanying drawings and described in the foregoing detailed description, it is to be understood that the present technology is not to be limited to just the embodiments disclosed, but that the technology described herein is capable of numerous rearrangements, modifications and substitutions without departing from the scope of the claims hereafter. The claims as follows are intended to include all modifications and alterations insofar as they come within the scope of the claims or the equivalent thereof.

What is claimed is:

1. An exercise mat apparatus as shown and described.

2. A method of using an exercise mat apparatus as shown and described.

3. An exercise mat system comprising a processor configured to execute computer executable instructions stored in a memory as shown and described.
